(19) United States
(12) Patent Application Publication
(10) Pub. No.: US 2013/0032416 A1
(43) Pub. Date: Feb. 7, 2013

(54) ULTRACAPACITOR SOFT-START APPARATUS AND METHOD

(71) Applicants: Joel P. Gouker, Fort Mill, SC (US); Jim Musser, Charlotte, NC (US)

(72) Inventors: Joel P. Gouker, Fort Mill, SC (US); Jim Musser, Charlotte, NC (US)

(21) Appl. No.: 13/195,921

(22) Filed: Aug. 2, 2011

(51) Int. Cl. B60L 7/10; H01M 10/44

(52) U.S. Cl. 180/65.31; 320/101

(57) ABSTRACT

A vehicle including a chassis, a plurality of wheels, a regenerative braking system, a fuel cell, a capacitive energy storage device and a controller. The wheels are coupled to the chassis. The regenerative braking system is operatively connected to the plurality of wheels. The capacitive energy storage device is electrically couplable to the fuel cell. The controller is electrically connected to the fuel cell. The controller routes electrical power from the fuel cell through the regenerative braking system to the capacitive energy storage device.

### FIELD OF THE INVENTION

The present invention relates to a vehicular fuel cell capacitor charging system, and, more particularly, to a vehicular fuel cell capacitor charging system in a vehicle with a regenerative braking system.

### BACKGROUND OF THE INVENTION

A fuel cell is an electrochemical cell that converts chemical energy from fuel into electrical energy. The electrical energy is generated by way of the reaction between a fuel supply and an oxidizing agent. The resulting reactants flowing into the cell and the chemical reaction produces products that flow out of it, while the electrolyte remains within the fuel cell. The fuel cell continues to produce electrical power continuously as long as the necessary reactant and oxidant flows are maintained thereto. Fuel cells are utilized in both stationary and mobile applications. For example, fuel cells are utilized on the type 212 submarine of the German and Italian navies.

Regenerative braking is utilized in many hybrid vehicles. When the brake pedal is depressed this causes the vehicle to engage a circuit to cause the electric motors that provide power to the wheels to act as generators thereby generating electricity by removing energy from the vehicle thus slowing of the vehicle. Typically the energy generated in the braking maneuver is stored in either an electrochemical device such as a battery or in a capacitive device such as an ultracapacitor.

The vehicle has been stopped and turned off the capacitive storage device may lose its charge. It is desirous to charge the capacitive energy storage device after starting the vehicle so that energy can be removed or added from it as needed. The discharged capacitive energy storage device will by its very nature act as a current sink until the voltage has reached its charged value. If a high current is drawn directly from the fuel cell by the capacitor bank that may cause the fuel cell to shutdown due to the over current situation.

Ultracapacitors are often utilized as the passive energy storage device used with the fuel cell in order to buffer transient loads. The charge current of the discharged ultracapacitor bank is higher than the maximum available current from the fuel cell. In order to overcome this difficulty the ultracapacitors must be pre-charged to a voltage close to the fuel cell voltage to prevent a large charging current from being drawn from the fuel cell by the low charged capacitor bank.

A prior art solution is to charge the capacitor bank but utilizing an external boost converter that receives energy from a 12 V battery. The solution may take a long time, such as 15 min., for the boost converter to provide the charging energy of the ultracapacitor bank.

What is needed in the art is a apparatus and a method to quickly charge the ultracapacitors without requiring the power to come from a 12 volt battery.

### SUMMARY

The invention in one form is directed to a vehicle including a chassis, a plurality of wheels, a regenerative braking system, a fuel cell, a capacitive energy storage device and a controller. The wheels are coupled to the chassis. The regenerative braking system is operatively connected to the plurality of wheels. The capacitive energy storage device is electrically couplable to the fuel cell. The controller is electrically connected to the fuel cell. The controller routes electrical power from the fuel cell through the regenerative braking system to the capacitive energy storage device.

The invention in another form is directed to a fuel cell control system for use with a vehicle having a regenerative braking system. The control system includes a fuel cell, a capacitive energy storage device and a controller. The capacitive energy storage device is electrically coupled to the fuel cell. The controller is configured to route electrical power from the fuel cell through the regenerative braking system to the capacitive energy storage device.

The invention in yet another form is directed to a method of charging a capacitive energy storage device of a vehicle having a regenerative braking system. The method includes the step of routing electrical power from a fuel cell through the regenerative braking system to the capacitive energy storage device under the control of the controller.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematical top view of a vehicle system utilizing an embodiment of a capacitive energy storage device charging system of the present invention;

FIG. 2 is a schematic of the existing configuration of a capacitive energy storage device charging system;

FIG. 3 is a schematic of system of a capacitive energy storage device charging system of FIG. 1; and

FIG. 4 is a schematical view of an embodiment of a method used by the capacitive energy storage device charging system of FIGS. 1 and 3.

Corresponding reference characters indicate corresponding parts throughout the several views. The exemplifications set out herein illustrate one embodiment of the invention and such exemplifications are not to be construed as limiting the scope of the invention in any manner.

### DETAILED DESCRIPTION

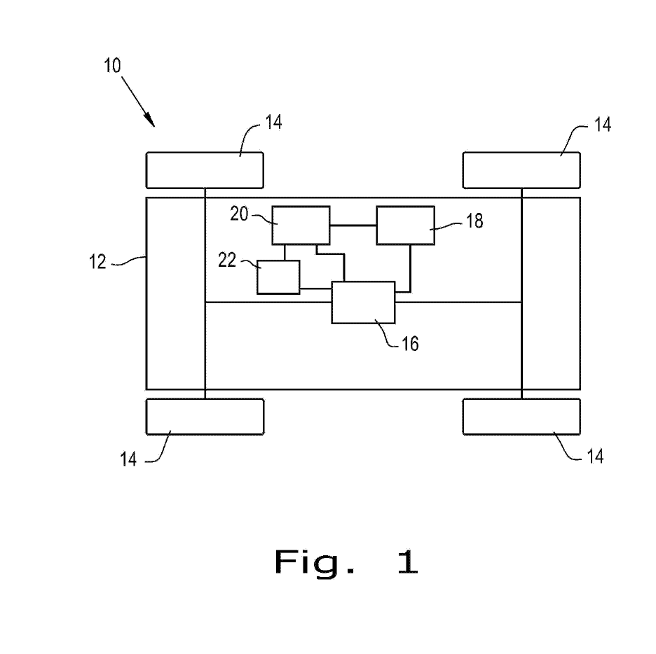

Referring now to the drawings, and more particularly to FIG. 1, there is illustrated a vehicle 10 including a chassis 12, wheels 14, a regenerative braking system 16, a capacitive energy storage device 18, control circuitry 20 and a fuel cell 22. Capacitive energy storage device 18 may be in the form of a bank of ultracapacitors, which are configured to absorb abrupt changes in the charging or discharging of the unit. Fuel cell 22 is activated when vehicle 10 is started, thereby causing fuel cell 22 to come online and start producing electrical power, which is used to drive wheels 14 and to provide the power to perform other vehicular tasks. During the deacceleration of vehicle 10 regenerative braking system 16 recoups some of the motion energy of vehicle 10 and sends it to capacitive energy storage device 18.

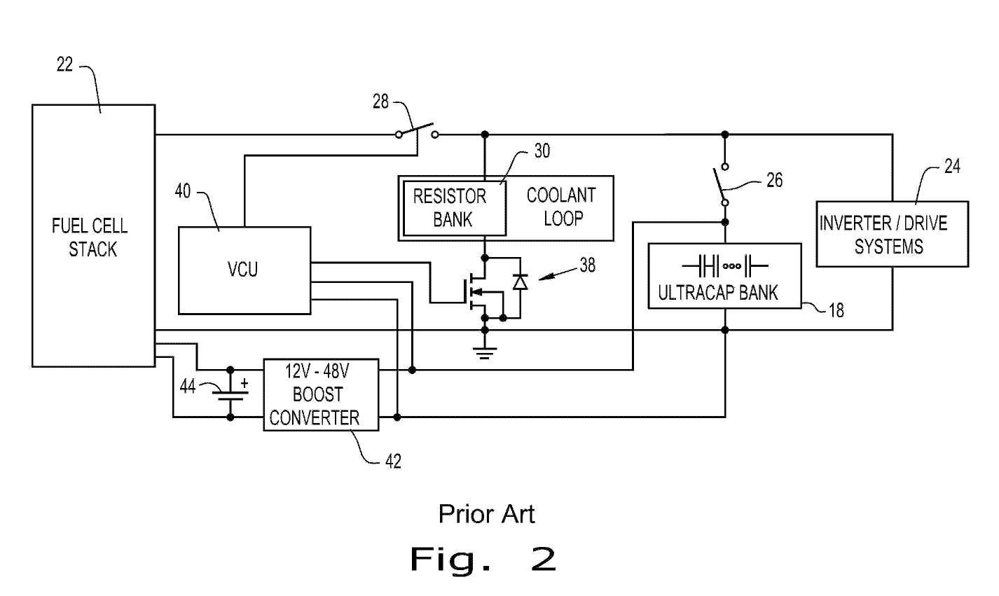

Now, additionally referring to FIG. 2 there is illustrated a schematic diagram showing how a prior art fuel cell system for a vehicle charged capacitive energy storage device 18. When fuel cell 22 was started, then boost converter 42 was used to charge capacitive energy storage device 18 up to a voltage commensurate with the output voltage of fuel cell 22. Boost converter 42 obtains energy from a 12 volt battery 44 and a typical charge time is 15 minutes, which significantly delays the direct connection of fuel cell 22 to capacitive energy storage device 18.

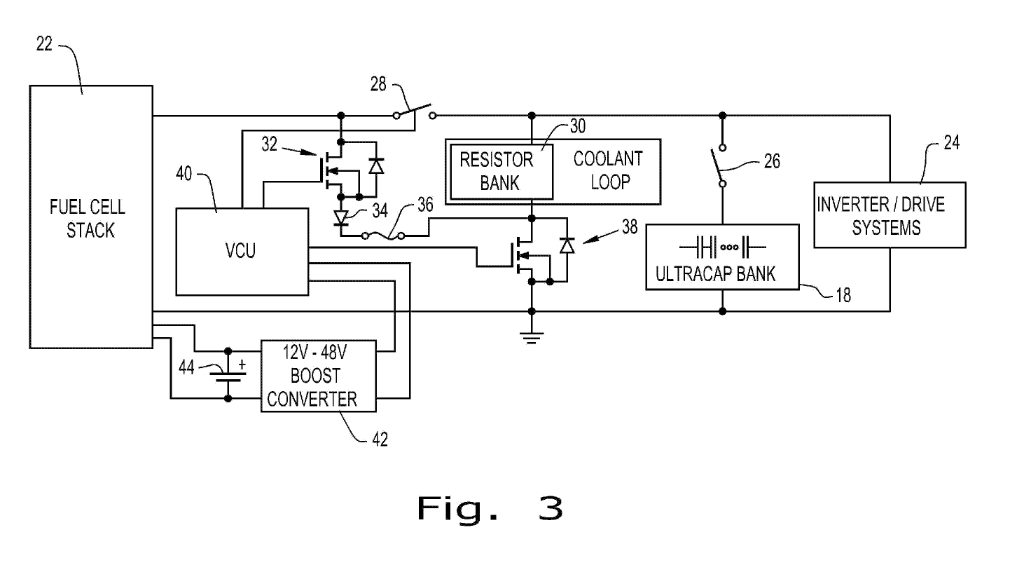

Now, additionally referring to FIG. 3 there is shown an embodiment of the charging apparatus of capacitive energy storage device 18 of the present invention including an inverter/drive system 24, a contactor 26, a contactor 28, a resistor bank 30, a solid state switch 32, a diode 34, a fuse 36, a solid state switch 38, a controller 40, a boost converter 42 and a 12 volt battery 44. Some of the elements of FIG. 2 are similar to those in FIG. 3 and bear the same reference number. Solid state switches 32 and 38 may be in the form of MOSFETs as depicted in the illustrations, although other devices are also contemplated.

Inverter/drive system 24 schematically represents the power providing apparatus that supplies motive power to wheels 14, as well as control circuitry associated therewith. The elements therein include a part of regenerative braking system 16 in that the motors that are used as generators when braking are therein. No further details of this system are provided for the sake of clarity and to focus on the present invention.

Contactor 26 is under the control of controller 40 and may be kept in an open condition to electrically isolate capacitive energy storage device 18 from the rest of the circuitry. Contactor 26 may be closed during normal operation of vehicle 10 allowing capacitive energy storage device 18 to absorb what would otherwise be abrupt changes in the current needed from fuel cell 22.

Contactor 28 is the main contactor and is used to isolate fuel cell 22 from the significant power consuming circuitry. This allows fuel cell 22 to be powered-up without a significant load being prematurely applied to fuel cell 22. During normal operation of vehicle 10 contactor 28 is in a closed position to thereby provide power to the electrical power consuming circuitry. A closing of contactors 26 and 28 at the same time without providing an initial charging of capacitive energy storage device 18 would result in an abrupt flow of current to capacitive energy storage device 18 and the overloading of fuel cell 22. The overloading of fuel cell 22 will lead to fuel cell 22 shutting down and may lead to damage to fuel cell 22.

Resistor bank 30 is part of regenerative braking system 16 and is used to dissipate excess power that is generated by the motor/generators which are also part of inverter/drive system 24, and could not be otherwise stored. Resistor bank 30 serves to provide a safe way of dissipating the energy that exceeds the capacity of capacitive energy storage device 18 to absorb.

Solid state switch 32, diode 34 and fuse 36 provided a circuit path from a power bus of fuel cell 22 to one side of resistor bank 30. Solid state switch 32 is under the control of controller 40. Solid state switch 38 provides a controlled connection of resistor bank 30 to the system ground to thereby bleed off and dissipate excess power in the system. Solid state switch 32 is under the control of controller 40.

Controller 40 may be a vehicle control unit (VCU) 40 that directs the functions of the present invention. Controller 40 receives power from boost converter 42 so that controller 40 can function to control solid state switches 32 and 38 and contactors 26 and 28, as well as other functions of vehicle 10.

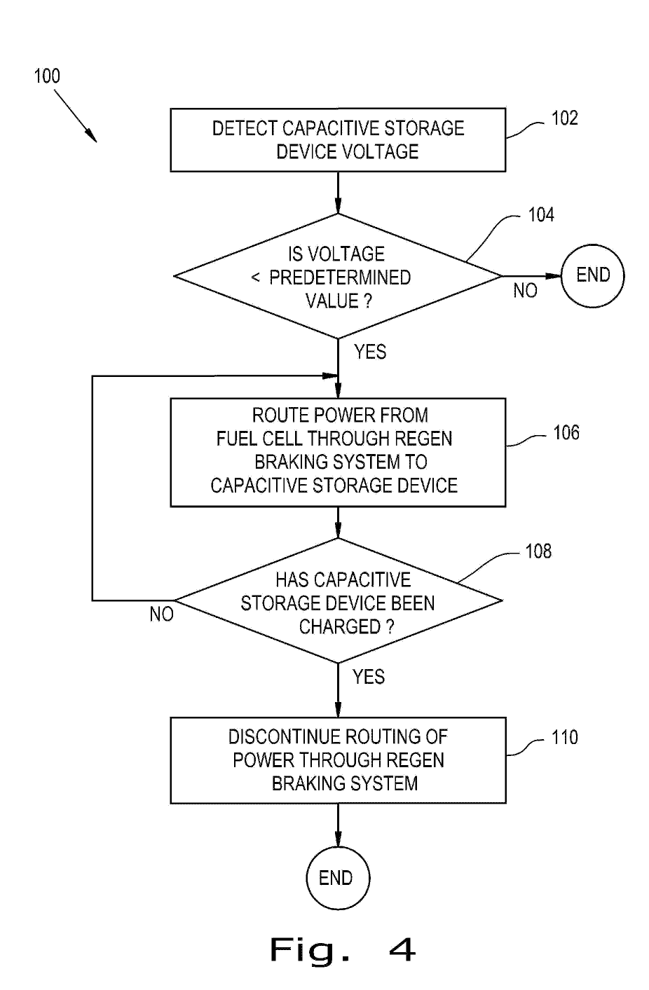

Now, additionally referring to FIG. 4, there is illustrated a method 100 having steps 102-110 that illustrate a portion of the present invention. At step 102, a determination is made as to whether capacitive energy storage device 18 needs to be charged. This is done by controller 40 detecting the voltage of capacitive energy storage device 18, or by simply assuming that capacitive energy storage device 18 needs to be charged upon every starting of vehicle 10. If the voltage is checked and it is above a predetermined value as determined in step 104, then method 100 terminates. If the voltage is below the predetermined value then method 100 proceeds to step 106.

At step 106, controller 40 causes electrical power to be routed through resistor bank 30, which is part of regenerative braking system 16 to capacitive energy storage device 18. This is accomplished by controller 40 opening solid state switch 38 to ensure there is no direct path to ground, keeping contactor 28 open, closing contactor 26 and closing solid state switch 32. These settings allow current to flow to capacitive energy storage device 18 as restricted by resistor bank 30. At step 108, it is determined if capacitive energy storage device 18 has been adequately charged, which may be to a voltage level that is substantially equal to the voltage output of fuel cell 22. The determination done at step 108 may be simply allowing the charging of capacitive energy storage device 18 started in step 106 to continue for a predetermined amount of time. Once it is determined that capacitive energy storage device 18 has been substantially charged, then method 100 proceeds to step 110.

At step 110, controller 40 discontinues the routing of a current flow through regenerative braking system 16 by opening solid state switch 32. The charging of capacitive energy storage device 18 using method 100 is substantially quicker than the prior art method. For example, in a test system the prior art method took 15 minutes to charge capacitive energy storage device 18, while the method of the present invention charged capacitive energy storage device 18 in approximately 2 minutes.

Although not shown as a step in method 100, controller 40 will close contactor 28 to allow a substantially direct connection of fuel cell 22 with capacitive energy storage device 18.

Additionally, for purposes of maintenance access and safety, capacitive energy storage device 18 can be discharged through regenerative braking system 16 by opening contactor 28, closing contactor 26 and closing solid state switch 38 to allow the stored energy in capacitive energy storage device 18 to be bled off.

The present invention advantageously reduces the charging time for capacitive energy storage device 18. Additionally the present invention allows boost converter 42 to be made smaller since it is not used to charge capacitive energy storage device 18. Yet another advantage of the present invention is that the main component to reduce the rush current into capacitive energy storage device 18, which is resistor bank 30, is already in place for used with regenerative braking system 16, thereby only requiring the additional switching of solid state switch 32 and the execution of method 100 by controller 40.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A vehicle, comprising:
a chassis;
a plurality of wheels coupled to said chassis;
a regenerative braking system operatively connected to said plurality of wheels;
a fuel cell connected to said chassis;
a capacitive energy storage device electrically couplable to said fuel cell; and
a controller electrically connected to said fuel cell, said controller routing power from said fuel cell through said regenerative braking system to said capacitive energy storage device.

2. The vehicle of claim 1, wherein said controller routes the power through said regenerative braking system when a voltage of said capacitive energy storage device is below a predetermined value.

3. The vehicle of claim 1, wherein said controller stops routing the power through said regenerative braking system once said capacitive energy storage device is substantially charged.

4. The vehicle of claim 3, wherein said controller routes power from said fuel cell to said capacitive energy storage device substantially directly after said controller stops routing the power through said regenerative braking system.

5. The vehicle of claim 1, wherein said controller routes the power through said regenerative braking system upon starting the vehicle.

6. The vehicle of claim 5, wherein said controller stops routing the power through said regenerative braking system upon one of an expiration of a predetermined time and a detection of a voltage of said capacitive energy storage device being above a predetermined value.

7. The vehicle of claim 1, wherein said controller electrically connects said capacitive energy storage device to said regenerative braking system to thereby discharge said capacitive energy storage device.

8. A fuel cell control system for use with a vehicle having a regenerative braking system, the control system comprising:
a fuel cell;
a capacitive energy storage device electrically couplable to said fuel cell; and
a controller configured to route electrical power from said fuel cell through the regenerative braking system to said capacitive energy storage device.

9. The control system of claim 8, wherein said controller routes the power through said regenerative braking system when a voltage of said capacitive energy storage device is below a predetermined value.

10. The control system of claim 8, wherein said controller stops routing the power through the regenerative braking system once said capacitive energy storage device is substantially charged.

11. The control system of claim 10, wherein said controller routes power from said fuel cell to said capacitive energy storage device substantially directly after said controller stops routing the power through the regenerative braking system.

12. The control system of claim 8, wherein said controller routes the power through the regenerative braking system upon the starting of the vehicle.

13. The control system of claim 12, wherein said controller stops routing the power through the regenerative braking system upon one of an expiration of a predetermined time and a detection of a voltage of said capacitive energy storage device being above a predetermined value.

14. The control system of claim 8, wherein said controller electrically connects said capacitive energy storage device to the regenerative braking system to thereby discharge said capacitive energy storage device.

15. A method of charging a capacitive energy storage device of a vehicle having a regenerative braking system, comprising the step of routing electrical power from a fuel cell through the regenerative braking system to the capacitive energy storage device under the control of a controller.

16. The method of claim 15, further comprising a steps of:
detecting a voltage of the capacitive energy storage device;
determining if said voltage is below a predetermined value; and
routing the power through the regenerative braking system when said voltage of said capacitive energy storage device is determined to be below said predetermined value in said determining step.

17. The method of claim 15, further comprising the step of stopping the routing of the power through the regenerative braking system once the capacitive energy storage device is substantially charged.

18. The method of claim 17, wherein said controller routes power from said fuel cell to said capacitive energy storage device substantially directly after said controller stops routing the power through said regenerative braking system.

19. The method of claim 15, wherein said controller routes the power through said regenerative braking system upon the starting of the vehicle.

20. The method of claim 19, wherein said controller stops routing the power through the regenerative braking system upon one of an expiration of a predetermined time and a detection of a voltage of the capacitive energy storage device being above a predetermined value.
